(19) United States
(12) Patent Application Publication
(10) Pub. No.: US 2026/0339292 A1
(43) Pub. Date: Oct. 29, 2026

(54) ROBOT CONTROL DEVICE, MACHINE TOOL, AND COOPERATION SYSTEM

(71) Applicant: FANUC CORPORATION, Yamanashi (JP)

(72) Inventors: Shuya SANO, Yamanashi (JP); Gou INABA, Yamanashi (JP)

(73) Assignee: FANUC CORPORATION, Yamanashi (JP)

(21) Appl. No.: 19/111,557

(22) PCT Filed: Oct. 28, 2022
(86) PCT No.: PCT/JP2022/040392

§ 371 Date: Mar. 13, 2025

(51) Int. Cl. G05B 19/4155

(52) U.S. Cl. CPC G05B 19/4155; G05B 2219/32043; G05B 2219/39001

(57) ABSTRACT

The present invention makes it possible to directly access a synchronous memory region that corresponds to an address of a ladder program of a machine tool from a robot control device. The robot control device according to the present invention operates in cooperation with a machine tool that is Sequence-controlled by a ladder program, the robot control device including a communication unit that communicates with the machine tool; and a robot program execution unit that designates an address that is assigned to a memory region of the machine tool for referencing by the ladder program, and is able to access the data of the address of the memory region via the communication unit.

### TECHNICAL FIELD

The present disclosure relates to a robot control device, a machine tool, and a cooperation system, and particularly relates to a cooperation system including a machine tool and a robot control device, the machine tool and the robot control device being configured to operate in cooperation, and to the robot control device and the machine tool used in the cooperation system.

### BACKGROUND ART

Cooperation systems in which a robot control device and a machine tool operate in cooperation are disclosed in, for example, Patent Documents 1, 2, and 3.

Patent Document 1 discloses an integrated control system of a work robot including a robot control CPU, a work tool control CPU, a shared memory, and a system bus connected to boards of the CPUs and the memory to integrate the CPUs and the memory. Patent Document 1 also discloses an integrated control system of a work robot connected to another system via a network CPU.

Patent Document 2 discloses a line facility control device applied in a case where a plurality of operation instruments are controlled by computer programs to assemble a plurality of models of products. In the line facility control device, a control program number for each operation instrument corresponding to a product model is stored in an X register, and the control program number for the operation instrument Corresponding to a designated model is designated based on information designating the product model and storage contents of the X register. Then, the line facility control device operates each operation instrument in accordance with a control program of the designated control program number.

Patent Document 3 discloses that a manufacturing system includes a plurality of kinds of manufacturing devices that are driven by operation programs with mutually different language specifications. The manufacturing system includes a cell control device that generates an operation program to be executed by each manufacturing device, and a communication device that transmits the operation program generated by the cell control device to the manufacturing device. A common language specification is predetermined for manufacturing devices of mutually different kinds. The cell control device includes a reading unit that reads a common computer program generated based on the common language specification, and a conversion unit that converts the common computer program into operation program of the respective manufacturing devices.

A ladder program that sequence-controls a work robot is disclosed in, for example, Patent Document 4. Patent Document 4 discloses that a ladder logic program is produced by using a functional block that executes processing set in advance, an internal counter that increments a count value by one each time operation of the functional block is completed, and a determination block that determines whether the count value of the internal counter is equal to an operation count value set to the determination block and outputs that operation conditions of the functional block are met when having determined that the count values are equal. Patent Document 4 also discloses that a computer program is displayed such that a user can set a process number indicating an optional process order with the determination block set as the operation count value, and the functional block is connected to an output of the determination block, which corresponds to the number of an executed process.

### CITATION LIST

### Patent Document

Patent Document 1: Japanese Unexamined Patent Application, Publication No. H09-323279

Patent Document 2: Japanese Unexamined Patent Application, Publication No. H06-114656

Patent Document 3: Japanese Unexamined Patent Application, Publication No. 2017-134722

Patent Document 4: Japanese Unexamined Patent Application, Publication No. 2016-081223

### DISCLOSURE OF THE INVENTION

### Problems to be Solved by the Invention

In a cooperation system in which a robot control device and a machine tool operate in cooperation, communication is performed between the machine tool and the robot control device to, for example, establish an interlock between operation of a robot controlled by the robot control device and machining by the machine tool. This communication typically uses, for example, IO communication. IO communication needs an IO instrument for IO communication, allocation between the IO instrument and a ladder, for example, modification of a ladder program for the machine tool, and the like, which complicates setting. In some cases, a robot needs to be introduced later to a machine tool in operation. In such a case, addition of hardware such as an IO instrument or modification of the ladder programs is difficult for end users, and thus it is necessary to request support from a machine tool builder.

Thus, a robot control device, a machine tool, and a cooperation system have been desired that eliminate necessity for an IO instrument for IO communication, allocation between the IO instrument and a ladder, modification of a ladder program for a machine tool, and the like.

### Means for Solving the Problems

A representative first aspect of the present disclosure is a robot control device that operates in cooperation with a machine tool that is sequence-controlled by a ladder program, the robot control device including a communication unit that communicates with the machine tool; and a robot program execution unit that designates an address that is assigned to a memory region of the machine tool for referencing by the ladder program, requests data of the address of the memory region from the machine tool via the communication unit, and is able to access the data from the machine tool via the communication unit.

A representative second aspect of the present disclosure is a machine tool that operates in cooperation with a robot control device that controls a robot with a robot program, the machine tool including a communication unit that communicates with the robot control device; a ladder program execution unit that executes a ladder program that performs sequence control of the machine tool; a memory region that the ladder program execution unit accesses; a synchronous memory region that is provided separately from the memory region; and a synchronous memory forwarding unit that stores write data that is acquired from the robot control device via the communication unit in the synchronous memory region, and forwards the stored write data to the memory region when execution of one cycle of the ladder program is completed.

A representative third aspect of the present disclosure is a cooperation system comprising a machine tool and a robot control device, the machine tool and the robot control device being configured to operate in cooperation, in which the robot control device is the robot control device of the first aspect or the machine tool is the machine tool of the second aspect.

### BRIEF DESCRIPTION OF THE DRAWINGS

FIG. 1 is a block diagram illustrating the configuration of a cooperation system of a first embodiment of the present disclosure.

FIG. 2 is a diagram illustrating an example of a robot program in a case of cooperation with a machine tool.

FIG. 3 is a block diagram illustrating the configuration of a cooperation system of a second embodiment of the present disclosure.

FIG. 4 is a flowchart illustrating operation of the cooperation system of the second embodiment.

FIG. 5 is a diagram for description of an example of tearing.

### PREFERRED MODE FOR CARRYING OUT THE INVENTION

Embodiments of the present disclosure will be described below in detail with reference to the accompanying drawings.

### First Embodiment

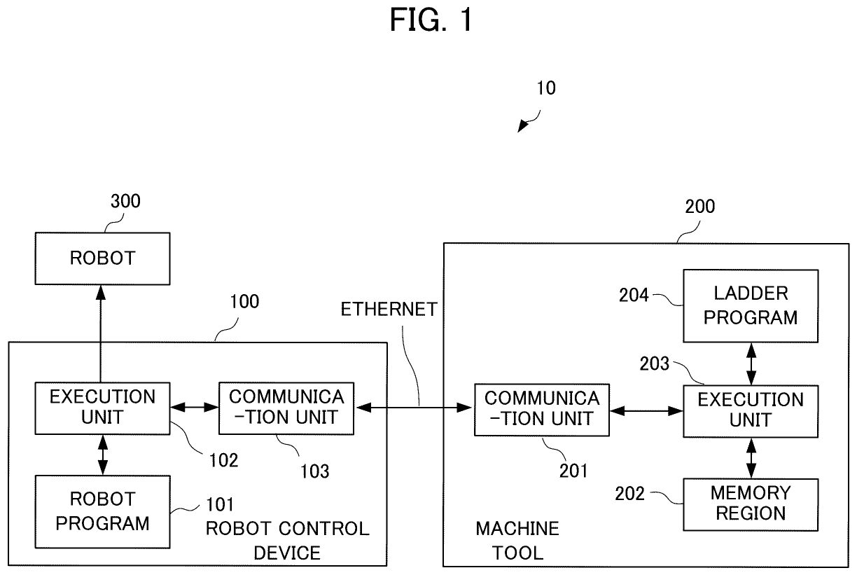

FIG. 1 is a block diagram illustrating the configuration of a cooperation system of a first embodiment of the present disclosure. As illustrated in FIG. 1, this cooperation system 10 includes a robot control device 100 and a machine tool 200. The robot control device 100 and the machine tool 200 operate in cooperation. The robot control device 100 controls a robot 300.

The robot control device 100 includes a robot program 101, an execution unit 102, and a communication unit 103. The execution unit 102 is a robot program execution unit. The robot program 101 is a computer program that controls the robot 300. For cooperation control of the robot control device 100 and the machine tool 200, the robot program 101 includes reference commands to a ladder program 204 of the machine tool 200. The robot program 101 is, for example, a robot ladder program that sequence-controls the robot 300.

The execution unit 102 controls the robot 300 based on the robot program 101. In a case where the robot program 101 includes reference commands, the execution unit 102 transmits a reference request to a communication unit 201 of the machine tool 200 via the communication unit 103. The reference request includes an address assigned to a memory region 202 for referencing by the ladder program 204 of the machine tool 200, which will be described later. Accordingly, the execution unit 102 designates an address assigned to the memory region 202 of the machine tool 200 for referencing by the ladder program 204 and is able to access data of the address of the memory region 202 via the communication unit 103. Having acquired the data designated at the address from the machine tool 200 via the communication unit 103, the execution unit 102 executes the robot program 101 by using the data. The communication unit 103 performs communication with the communication unit 201 of the machine tool 200 through an Ethernet® or the like.

The machine tool 200 includes the communication unit 201, the memory region 202, an execution unit 203, and the ladder program 204. The execution unit 203 is a ladder program execution unit.

The communication unit 201 performs communication with the communication unit 103 through an Ethernet® or the like.

The memory region 202 stores data that is necessary for the execution unit 203 to execute the ladder program 204. The memory region 202 is assigned with an address to reference data at execution of the ladder program.

The execution unit 203 reads the ladder program 204 and controls machining of a machining target object (workpiece) by the machine tool 200. When having received a reference request including an address via the communication unit 201, the execution unit 203 references the memory region 202 based on the address and reads data designated with the address. The execution unit 203 transmits the read data to the communication unit 103 of the robot control device 100 via the communication unit 201.

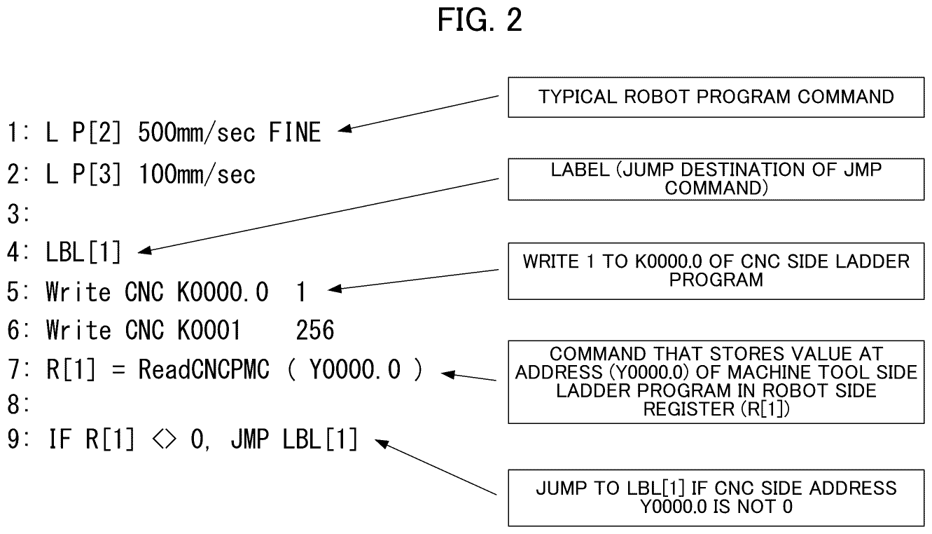

FIG. 2 is a diagram illustrating an example of the robot program in a case of cooperation with the machine tool. In the robot program illustrated in FIG. 2, “7: R[1]=ReadCNCPMC (Y0000.0)” is a command that stores data corresponding to the address (Y0000.0) of the ladder program 204 on the machine tool 200 side in a register (R[1]) of the execution unit 102. The data corresponding to the address (Y0000.0) is stored in the memory region 202. The execution unit 102 designates the address (Y0000.0) on the ladder program 204 of the machine tool 200 as an argument and performs a reference request. A return value from the machine tool 200 is the data corresponding to the designated address (Y0000.0), which is read from the memory region 202. The execution unit 102 stores the data corresponding to the address (Y0000.0) in the register R[1] in the execution unit 102. As illustrated in FIG. 2, the robot program also includes commands other than robot operation commands.

The above description is made on an example in which the execution unit 102 reads data from the memory region 202 of the machine tool 200, but the present embodiment is also applicable to an example in which the execution unit 102 writes data to the memory region 202 of the machine tool 200. In this case, the robot program 101 of the robot control device 100 includes write commands to the ladder program 204 of the machine tool 200. Then, the execution unit 102 transmits a write request to the communication unit 201 of the machine tool 200 via the communication unit 103. The write request includes an address assigned to the memory region 202 of the machine tool 200 and write data.

In the present embodiment described above, the robot control device is able to designate the memory region of the machine tool with the address of the ladder program and access the memory region. This eliminates necessity for an IO instrument for IO communication, allocation between the IO instrument and a ladder, modification of the ladder program for the machine tool, and the like. As a result, even when retrofitting the robot control device to an existing machine tool, an end user can handle it.

### Second Embodiment

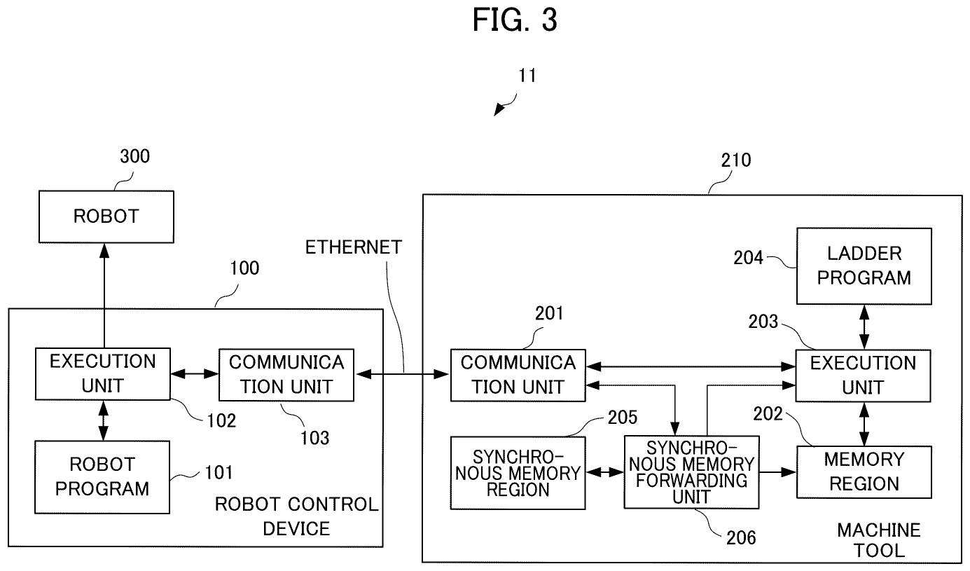

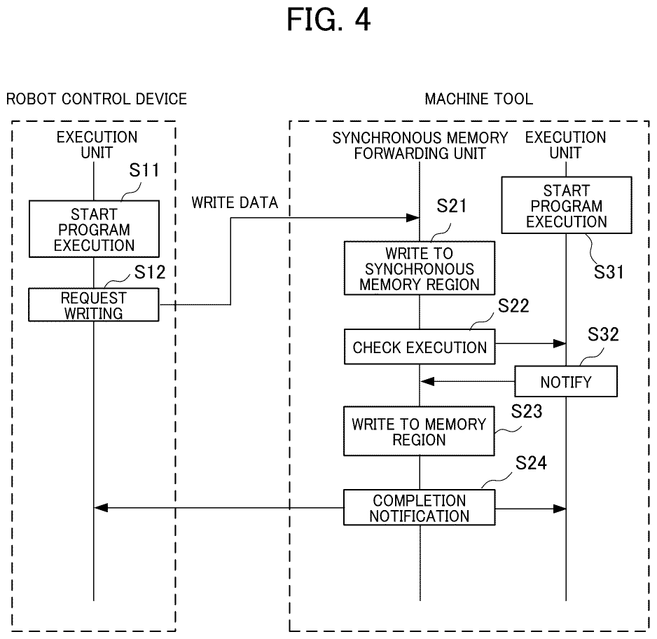

FIG. 3 is a block diagram illustrating the configuration of a cooperation system of a second embodiment of the present disclosure. FIG. 4 is a flowchart illustrating operation of the cooperation system of the second embodiment. As illustrated in FIG. 3, this cooperation system 11 includes the robot control device 100 and a machine tool 210. In the cooperation system 11, the machine tool 200 of the cooperation system 10 illustrated in FIG. 1 is replaced with the machine tool 210.

The machine tool 210 includes the communication unit 201, the memory region 202, the execution unit 203, the ladder program 204, a synchronous memory region 205, and a synchronous memory forwarding unit 206. The configuration of the machine tool 210 other than the synchronous memory region 205 and the synchronous memory forwarding unit 206 is the same as that of the machine tool 200, and thus description thereof is omitted.

The operation of the cooperation system 11 will be described below with reference to FIGS. 3 and 4. The robot program 101 of the robot control device 100 includes write commands to the ladder program 204 of the machine tool 200.

As illustrated in FIG. 4, the execution unit 102 of the robot control device 100 starts execution of the robot program 101 (Step S11), and transmits a write request to the communication unit 201 of the machine tool 200 via the communication unit 103 in a case where the robot program 101 includes write commands (Step S12). The write request includes an address assigned to the synchronous memory region 205 of the machine tool 200 and write data.

As illustrated in FIG. 4, the synchronous memory forwarding unit 206 writes the write data to the synchronous memory region 205 based on the write request acquired via the communication unit 201 and stores data (Step S21). The execution unit 203 of the machine tool 200 has already started execution of the ladder program 204 (Step S31). The synchronous memory forwarding unit 206 checks the execution status of the ladder program 204 with the execution unit 203 (Step S22). In a case where execution of one cycle of the ladder program 204 is completed, the execution unit 203 notifies the synchronous memory forwarding unit 206 of the execution completion (Step S32).

If the synchronous memory forwarding unit 206 has not received the execution completion notification from the execution unit 203, the synchronous memory forwarding unit 206 stands by to wait for completion of one cycle of the ladder program 204. If the synchronous memory forwarding unit 206 has received the execution completion notification, the synchronous memory forwarding unit 206 references contents of the synchronous memory region 205 and writes (forwards) data written in the synchronous memory region 205 to the memory region 202, thereby updating data (Step S23). Thereafter, the synchronous memory forwarding unit 206 notifies the robot control device 100 of the data update and writing completion (completion notification) via the communication unit 201, and also performs the completion notification to the execution unit 203 (Step S24). Having received the completion notification, the execution unit 203 operates the ladder program 204 by using the updated data in the memory region 202.

In the robot program illustrated in FIG. 2, “5: CNC K0000.1 1” is a command that writes “1” to the synchronous memory region 205 designated with an address K0000.0 of the ladder program 204 on the machine tool 200 side. The execution unit 102 designates the address (K0000.0) on the ladder program 204 of the machine tool 200 and performs a write request. Having acquired the write request, the synchronous memory forwarding unit 206 of the machine tool 200 performs the operation illustrated in FIG. 4.

In the present embodiment described above, the robot control device is able to designate the synchronous memory region of the machine tool with the address of the ladder program and access and write to the synchronous memory region. This eliminates necessity for an IO instrument for IO communication, allocation between the 10 instrument and a ladder, modification of the ladder program for the machine tool, and the like. As a result, even when retrofitting the robot control device to an existing machine tool, an end user can handle it. Moreover, in the present embodiment, it is possible to prevent unexpected malfunctions such as tearing.

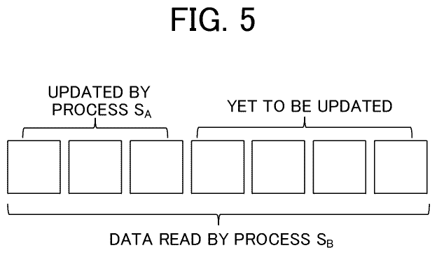

Tearing refers to data corruption by reading or writing data at inappropriate timings. FIG. 5 is a diagram for description of an example of tearing. As illustrated in FIG. 5, for example, consider a case where there is an 8-bit memory region shared by a plurality of processes, a process S_{A} constantly updates data one bit at a time, and a process S_{B} reads all 8 bits at once at an optional timing. In such a case, asynchronous reading and writing causes problems. If the process S_{B} asynchronously performs reading while the process S_{A} is writing, inconsistent data is read by the process S_{B} since data is being updated by the process S_{A}.

In the present embodiment, since the synchronous memory region is provided separately from the memory region, it is possible to prevent asynchronous data reading of the memory region at inappropriate timings, thereby preventing tearing.

The robot control device and the machine tool of the cooperation system in each embodiment described above can be each implemented by hardware, software, or their combination to implement functional blocks included in the robot control device and the machine tool. Being implemented by software means being implemented by a computer reading and executing a computer program.

To implement functional blocks included in the robot control device and the machine tool in the present embodiment by software or a combination thereof, the robot control device and the machine tool each specifically include an arithmetic processing device such as a central processing unit (CPU). The arithmetic processing device functions as an execution unit. The robot control device and the machine tool each also include an auxiliary storage device such as a hard disk drive (HDD) storing various control programs such as application software and an operating system (OS), and a main storage device such as a random access memory (RAM) for storing data temporarily needed by the arithmetic processing device when executing a computer program. The main storage device includes at least one of the memory region and the synchronous memory region.

Then, in the robot control device and the machine tool, the arithmetic processing device reads application software or the OS from the auxiliary storage device and performs arithmetic processing based on the application software or OS while loading the read application software or OS onto the main storage device. In addition, various kinds of hardware included in each device are controlled based on the result of the arithmetic processing. Accordingly, functional blocks of the present embodiment are implemented.

Components included in each of the robot control device and the machine tool may be implemented by hardware including electronic circuits and the like. In a case where each of the robot control device and the machine tool is constituted by hardware, some or all functions of components included in each of the robot control device and the machine tool may be constituted by an integrated circuit (IC) such as an application specific integrated circuit (ASIC), a gate array, a field programmable gate array (FPGA), or a complex programmable logic device (CPLD).

Computer programs may be stored by using various types of non-transitory computer readable media and supplied to a computer. The non-transitory computer readable media include various types of tangible storage media. Examples of the non-transitory computer readable media include a magnetic storage medium (for example, hard disk drive), a magneto-optical storage medium (for example, magneto-optical disc), a CD-ROM (read only memory), a CD-R, a CD-R/W, and a semiconductor memory (for example, mask ROM, programmable ROM (PROM), erasable PROM (EPROM), flash ROM, and random access memory (RAM)). Computer programs may be supplied to a computer through various types of transitory computer readable media.

An effect of at least one embodiment described above is that the robot control device is able to designate the memory region or synchronous memory region of the machine tool with the address of the ladder program and access the memory region or synchronous memory region. This eliminates necessity for an IO instrument for IO communication, allocation between the IO instrument and a ladder, modification of the ladder program for the machine tool, and the like. This leads to an effect that even when retrofitting the robot control device to an existing machine tool, an end user can handle it.

Although the present disclosure is described above, the present disclosure is not limited to the individual embodiments described above. The embodiments may be subjected to various kinds of addition, replacement, change, partial deletion, and the like without departing from the scope of the present disclosure or departing from the gist of the present disclosure derived from contents written in the claims and their equivalents. The embodiments may be combined. For example, the orders of operation and processing in the above-described embodiments are presented as examples, and the present invention is not limited thereto.

The following supplements are further disclosed in addition to the above-described embodiments and modifications.

### Supplement 1

A robot control device (100) that operates in cooperation with a machine tool (200, 210) that is sequence-controlled by a ladder program, the robot control device including a communication unit (103) that communicates with the machine tool; and a robot program execution unit (102) that designates an address assigned to a memory region (202) of the machine tool for referencing by the ladder program, requests data of the address of the memory region from the machine tool via the communication unit, and is able to access the data from the machine tool via the communication unit.

### Supplement 2

The robot control device according to Supplement (1), in which the robot program execution unit (102) designates the memory region at the address from a command of a robot program.

### Supplement 3

The robot control device according to Supplement (2), in which a robot ladder program that performs sequence control is included as the robot program, and the robot ladder program designates the memory region at the address and accesses the memory region.

### Supplement 4

A cooperation system (10, 11) including the robot control device (100) according to any one of Supplements (1) to 3 and a machine tool (200, 210), the robot control device and the machine tool being configured to operate in cooperation, in which the machine tool (200, 210) includes a ladder program execution unit (203) that executes a ladder program that performs sequence control of the machine tool, a memory region (202) that the ladder program execution unit accesses, and a communication unit (201) that communicates with the robot control device, and an address for referencing by the ladder program is assigned to the memory region.

### Supplement 5

A machine tool (210) that operates in cooperation with a robot control device (100) that controls a robot with a robot program, the machine tool including a communication unit (201) that communicates with the robot control device; a ladder program execution unit (203) that executes a ladder program that performs sequence control of the machine tool; a memory region (202) that the ladder program execution unit accesses; a synchronous memory region (205) that is provided separately from the memory region, and a synchronous memory forwarding unit (206) that stores write data that is acquired from the robot control device via the communication unit in the synchronous memory region, and forwards the stored write data to the memory region when execution of one cycle of the ladder program is completed.

### Supplement 6

A robot control device (100) that operates in cooperation with the machine tool (210) according to Supplement (5), the robot control device (100) including a communication unit (103) that communicates with the machine tool; and a robot program execution unit (102) that designates an address assigned to a synchronous memory region of the machine tool for referencing by the ladder program and transmits the write data in the synchronous memory region to the machine tool via the communication unit.

### Supplement 7

A cooperation system (11) including a machine tool (210) and a robot control device (100), the machine tool and the robot control device being configured to operate in cooperation, in which the machine tool (210) includes a communication unit (201) that communicates with the robot control device, a ladder program execution unit (203) that executes a ladder program that performs sequence control of the machine tool, a memory region (202) that the ladder program execution unit accesses, a synchronous memory region (205) that is provided separately from the memory region, and a synchronous memory forwarding unit (206) that stores write data that is acquired from the robot control device via the communication unit in the synchronous memory region, and forwards the stored write data to the memory region when execution of one cycle of the ladder program is completed, and the robot control device includes a communication unit (103) that communicates with the machine tool, and a robot program execution unit (102) that designates an address assigned to the synchronous memory region for referencing by the ladder program and transmits write data in the synchronous memory region to the machine tool via the communication unit.

### EXPLANATION OF REFERENCE NUMERALS

10, 11 cooperation system
100 robot control device
101 robot program
102 execution unit
103 communication unit
200, 210 machine tool
201 Communication unit
202 memory region
203 execution unit
204 ladder program
205 synchronous memory region
206 synchronous memory forwarding unit

1. A robot control device that operates in cooperation with a machine tool that is sequence-controlled by a ladder program, the robot control device comprising:
a communication unit that communicates with the machine tool; and
a robot program execution unit that designates an address that is assigned to a memory region of the machine tool for referencing by the ladder program, and is able to access data of the address of the memory region via the communication unit.

2. The robot control device according to claim 1, wherein the robot program execution unit designates the memory region at the address from a command of a robot program.

3. The robot control device according to claim 2, wherein
a robot ladder program that performs sequence control is included as the robot program, and
the robot ladder program designates the memory region at the address and accesses the memory region.

4. A cooperation system comprising the robot control device according to claim 1 and a machine tool, the robot control device and the machine tool being configured to operate in cooperation, wherein
the machine tool includes
a ladder program execution unit that executes a ladder program that performs sequence control of the machine tool,
a memory region that the ladder program execution unit accesses, and
a communication unit that communicates with the robot control device, and
wherein an address for referencing by the ladder program is assigned to the memory region.

5. A machine tool that operates in cooperation with a robot control device that controls a robot with a robot program, the machine tool comprising:
a communication unit that communicates with the robot control device;
a ladder program execution unit that executes a ladder program that performs sequence control of the machine tool;
a memory region that the ladder program execution unit accesses;
a synchronous memory region that is provided separately from the memory region; and
a synchronous memory forwarding unit that stores write data that is acquired from the robot control device via the communication unit in the synchronous memory region, and forwards the stored write data to the memory region when execution of one cycle of the ladder program is completed.

6. A robot control device that operates in cooperation with the machine tool according to claim 5, the robot control device comprising:
a communication unit that communicates with the machine tool; and
a robot program execution unit that designates an address assigned to a synchronous memory region of the machine tool for referencing by the ladder program and transmits the write data in the synchronous memory region to the machine tool via the communication unit.

7. A cooperation system comprising a machine tool and a robot control device, the machine tool and the robot control device being configured to operate in cooperation, wherein
the machine tool includes
a communication unit that communicates with the robot control device,
a ladder program execution unit that executes a ladder program that performs sequence control of the machine tool,
a memory region that the ladder program execution unit accesses,
a synchronous memory region that is provided separately from the memory region, and
a synchronous memory forwarding unit that stores write data that is acquired from the robot control device via the communication unit in the synchronous memory region, and forwards the stored write data to the memory region when execution of one cycle of the ladder program is completed, and
the robot control device includes
a communication unit that communicates with the machine tool, and
a robot program execution unit that designates an address assigned to the synchronous memory region for referencing by the ladder program and transmits write data in the synchronous memory region to the machine tool via the communication unit.
